(19) United States
(12) Patent Application Publication
(10) Pub. No.: US 2003/0046382 A1
(43) Pub. Date: Mar. 6, 2003

(54) System and method for scalable multi-level remote diagnosis and predictive maintenance

(76) Inventor: Sascha Nick, Paris (FR)

Correspondence Address: LEYDIG VOIT & MAYER, LTD, 6815 WEAVER ROAD, ROCKFORD, IL, 61114-8018, US

(21) Appl. No.: 09/934,000

(22) Filed: Aug. 21, 2001

(51) Int. Cl. G06F 15/173

(52) U.S. Cl. 709/224

(57) ABSTRACT

A system and method for remote diagnosis and predictive maintenance of devices, machines, and systems has been presented. The system detects signals of one or more operating and condition parameters and compares the detected signals to a signal model maintained locally with respect to the location of the device, machine, or system for anomalies. Information describing each anomaly is transmitted to a location remote from the device, machine, or system for diagnosis. The diagnosis includes an initial analysis of the information by diagnostic tools maintained at the remote location, a subsequent analysis of the information by diagnostic tools maintained elsewhere if the initial analysis fails to provide a diagnosis and a final analysis by a team of humans aided by a collaborative environment if the initial and subsequent analyses fails to provide a diagnosis. The diagnosis is transmitted to a maintenance service for repair of the device, machine, or system.

### FIELD OF THE INVENTION

The present invention relates generally to predictive maintenance, and more particularly relates to diagnosing processes and machines at remote locations.

### BACKGROUND OF THE INVENTION

Manufacturing down-time due to machine failure costs industries billions of dollars each year. Several techniques for managing these costs have been developed and are now widely used. These techniques include preventive maintenance and predictive maintenance.

Time-based preventive maintenance is one of the popular techniques currently employed by the manufacturing industry for reducing the number of unscheduled shut downs of a manufacturing line. In time-based preventive maintenance, components are inspected and/or replaced at periodic intervals. For example, a bearing rated for so many hours of operation is always replaced after a set number of operational hours regardless of its condition.

Chart 1 shows typical failure probability charts for a variety of components. Curve 1000 illustrates the failure probability of components subject to dominant age-related failure and “infant mortality” (i.e., high initial failure rates decreasing over time to a stable level). Curve 1002 illustrates the failure probability of components having a dominant age-related failure mode only. Curves 1004, 1006 illustrate the failure probability of components subject to failure fatigue. Curve 1008 illustrates the failure probability of complex electromechanical components without a dominant failure mode and electromechanical components that are not subject to an excessive force. Curve 1010 illustrates the failure probability of electronic components (e.g., controllers, sensors, actuators, drives, regulators, displays, Places, computers).

Time based preventive maintenance decreases failures for components that exhibit a failure probability illustrated in curves 1000, 1002. These components, which comprise a low percentage of approximately four to six percent of installed equipment, include complex mechanical equipment subject to premature failures (e.g., gearboxes and transmissions) and mechanical equipment with a dominant age-related failure mode (e.g., pumps, valves, pipes). Preventive maintenance ease or increase failures for components that exhibit a failure probability similar to the failure probability illustrated in curves 1004-1008. However, if some other component actually is disrupted during the maintenance, the failure rate of these component actually increases with time based preventive maintenance.

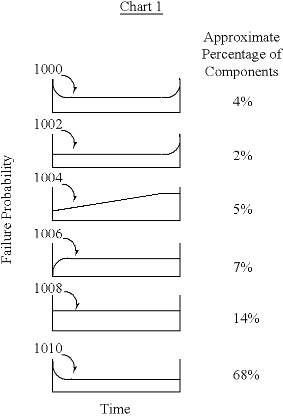

Time based preventive maintenance actually increases the failure rate of electronic components by prematurely shutting down a manufacturing line for scheduled maintenance and introducing “infant mortality” in what is an otherwise stable system. Curve 1100 in chart 2 illustrated the increased failure probability due to “infant mortality” when electronic components are replaced due to preventive maintenance and curve 1102 illustrates the failure probability with no preventive maintenance performed.

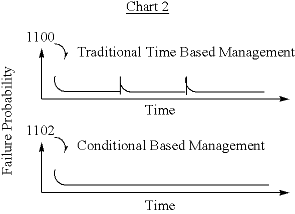

The manufacturing industry has recognized these and other problems with preventive maintenance, but the alternatives are expensive. One of these alternative techniques is predictive maintenance. In its most simple form, predictive maintenance monitors the condition of operating parameters on a machine over a period of time. Predictions are generated of when a component should be replaced based on detected changes in the operating parameters. The changes can also be used to indicate specific faults in the system being monitored. Techniques for predictive maintenance that are available today, however, are either poorly matched to the particular circumstances and, therefore, less than completely effective or they are so expensive as to be prohibitive in all but the most expensive manufacturing settings.

Predictive maintenance systems have had only a limited acceptance by the manufacturing industry. It has been estimated that these systems are being used today in less than one percent of the total maintenance market. Many predictive maintenance systems are expensive, require local experts, and are often unstable or unreliable. These systems require continuous monitoring of operating parameters and conditions. This continuous monitoring results in an enormous amount of data that, in turn, requires significant processing power. As a result, predictive maintenance is often cost-prohibitive. Due to the expense of the installation and maintenance of these predictive systems, manufacturers either limit the number of systems installed in a manufacturing site, limit the number of components at the site that are monitored, or perform time sampling of components instead of continuous monitoring. The reduced monitoring reduces the effectiveness of the system and ultimately results in its unreliable performance.

Other problems that are a direct or indirect result of manufacturer's efforts to reduce cost have been encountered. One problem is when on-site technicians periodically collect machine condition data. The periodic manual collection of data is expensive and results in discontinuous monitoring. The discontinuous monitoring leads to an increased failure rate of machines due to machines failing before a failure is diagnosed due to the lag in time. Additionally, the sensors used to collect the data may not be permanently mounted, which results in the sensors being located at a slightly different location each time data is collected. As a result, any difference between data measurements may be due to the change in location of the sensors and not the machine being monitored.

Another problem is with the use of experts that analyze the data. Locally based experts may be difficult to find. Transmitting all data to an expert for analysis requires bandwidth. Additionally, experts are expensive and often become a bottleneck in the process.

Another problem encountered is when sophisticated local modeling and signal analysis tools are used. The configuration of these tools requires a skill level that is not always available. Additionally, the model becomes obsolete when a minor change to the machine is made, requiring re-generation of a new model. Conversely, centralized signal analysis can become overloaded as additional data is received for analysis.

Another problem is that present systems lack salability. These systems are typically designed for a specific implementation and become overloaded as the number of systems being monitored increases. These systems also require complex customization for each new system.

Another problem is the reliability of sensor signals used to monitor the system. It has been estimated that fifty percent of monitoring problems are a direct result of sensor failure, sensor obstruction (e.g., oil, dust, or other particles), and severed or damaged sensor cables. The present monitoring systems typically do not monitor the health of the sensors used to monitor the system.

### BRIEF SUMMARY OF THE INVENTION

The invention provides a method for remotely monitoring and diagnosing operations of a device, machine, or system (hereinafter called “machine”) and for performing predictive maintenance on a machine. A signal model of the machine is created based on sensed signals during normal operation of the machine. Signals representative of the machine's operating and condition parameters are sensed and compared to the signal model locally maintained proximate to the device in order to detect anomalies. Once an anomaly is detected, information describing each anomaly is transmitted to a location remote from the machine. The information is diagnosed at the remote location. The signal model is adapted to work with the remaining sensors if a failed sensor is detected.

The diagnosis includes an initial analysis of the information by diagnostic tools maintained at the remote location. The diagnostic tools include a library of patterns comprising information describing systemic anomalies and a library of patterns comprising information describing component anomalies. The information is compared to patterns in the library describing systemic anomalies and component anomalies for a match. If a match is found, a diagnosis is made.

If the initial analysis fails to provide a diagnosis, a subsequent analysis of the information by diagnostic tools maintained elsewhere is performed. A final analysis by a team of humans aided by a collaborative environment is performed if the initial and subsequent analyses fail to provide a diagnosis. The diagnosis of the anomaly is reported to a location capable of attending to repair of the machine. Each new diagnosis is added to the appropriate pattern library for analysis of future anomalies, which improves the diagnostic capability of the system.

Other features and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 is a block diagram generally illustrating an exemplary environment in which the present invention operates;

FIG. 2 is a flow chart of a method of diagnosing failures of components in accordance with the present invention;

FIG. 3 is a block diagram of an exemplary end user plant in which part of the present invention operates according to one embodiment of the present invention;

FIG. 4 is a block diagram of an embodiment of a local detector in accordance with the present invention;

FIG. 5a is a flow chart of an exemplary process performed in level 202 of the flow chart of FIG. 2;

FIG. 5b is a flow chart of an exemplary process performed in level 204 of the flow chart of FIG. 2;

FIG. 5c is a flow chart of an exemplary process performed in level 206 of the flow chart of FIG. 2;

FIG. 5d is a flow chart of an exemplary process performed in level 208 of the flow chart of FIG. 2; and

FIG. 6 is a block diagram illustrating the step of auto-configuring a communications link in accordance with the present invention;

While the invention will be described in connection with certain embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Turning to the drawings, wherein like reference numerals refer to like elements, the invention is illustrated as being implemented in a suitable operating environment. The invention may also be practiced in distributed computing environments where tasks are performed by remote processing devices that are linked through a communications network. In a distributed computing environment, program modules may be located in both local and remote memory storage devices.

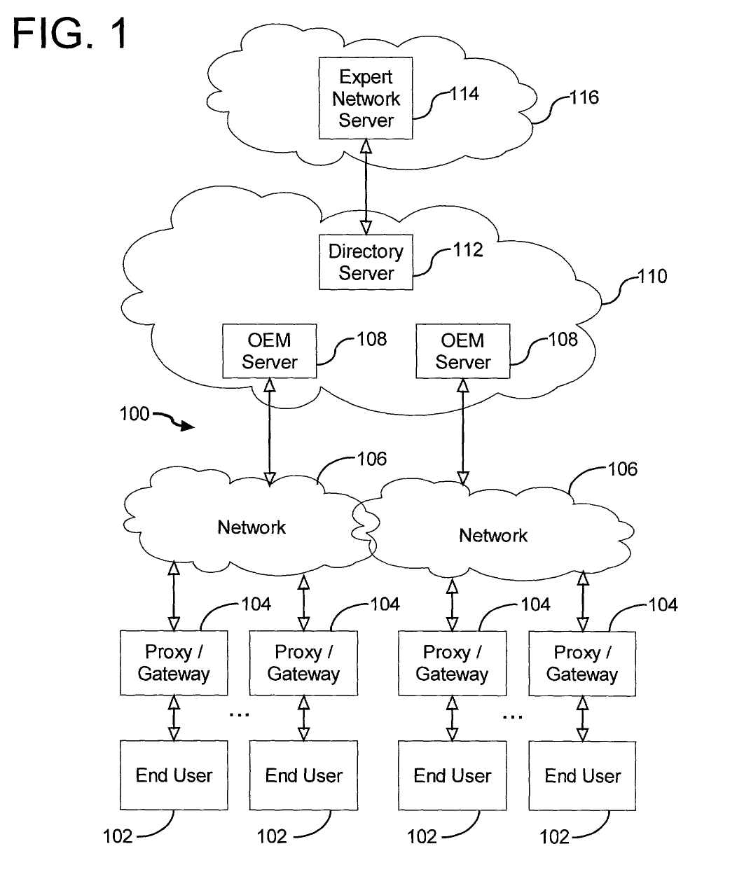

FIG. 1 illustrates an example of a suitable operating environment 100 in which the invention may be implemented. The operating environment 100 is only one example of a suitable computing environment and is not intended to suggest any limitation as to the scope of use or functionality of the invention. The operating environment 100 includes one or more end users 102 in communication with an OEM server 108 via a network 106. Each end user 102 comprises a location where one or more machines or devices are located. For example, an end user 102 may be a manufacturing plant, a remote station or machine, a business, a home, a vehicle, or any other place where reliability of equipment is a concern. The end users 102 are connected to the network 106 via proxy/gateways 104. The network 106 in one embodiment is the Internet. Alternatively, the network 106 may be a virtual private network, a dedicated network, a public switched network, a wireless network, a satellite link, or any other type of communication link.

The OEM servers 108 communicate with each other in a peer-to-peer network 110. Those skilled in the art will recognize that the network 110 may be other type of networks such as a virtual private network, a dedicated network, or any other type of communication link. A directory server 112 maintains a list of all OEM servers 108 and, as described hereinbelow, is used to aid OEM servers find other OEM servers. The directory server 112 also communicates with the expert network server 114. The expert network 114 maintains a list of available experts located in a collaborative network 116 that can be used to solve particular problems.

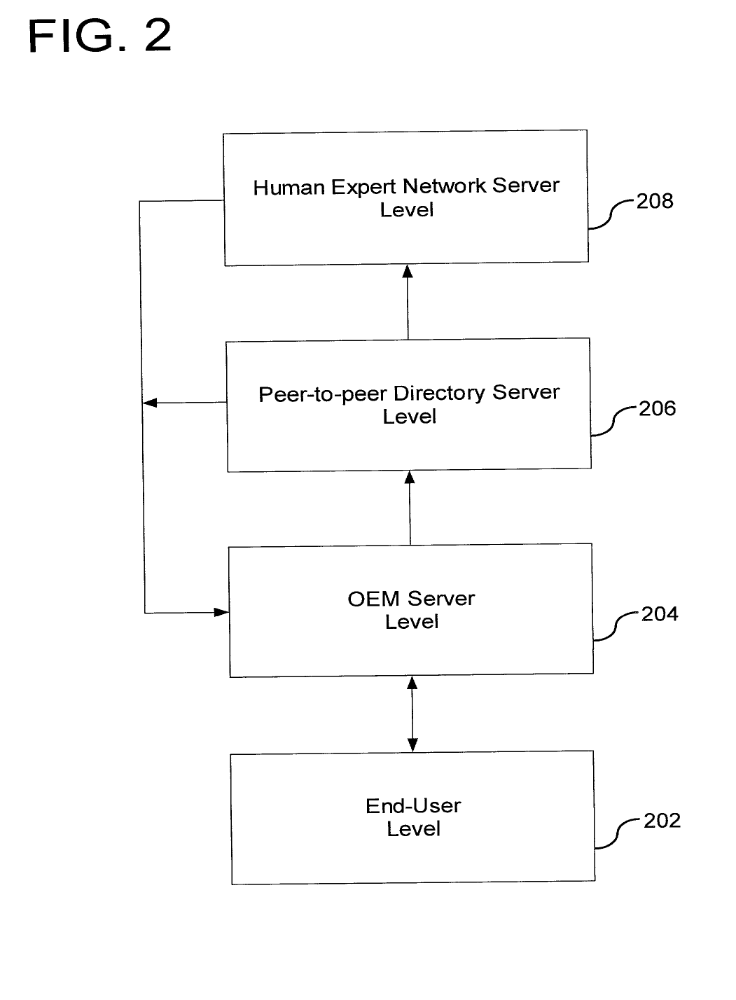

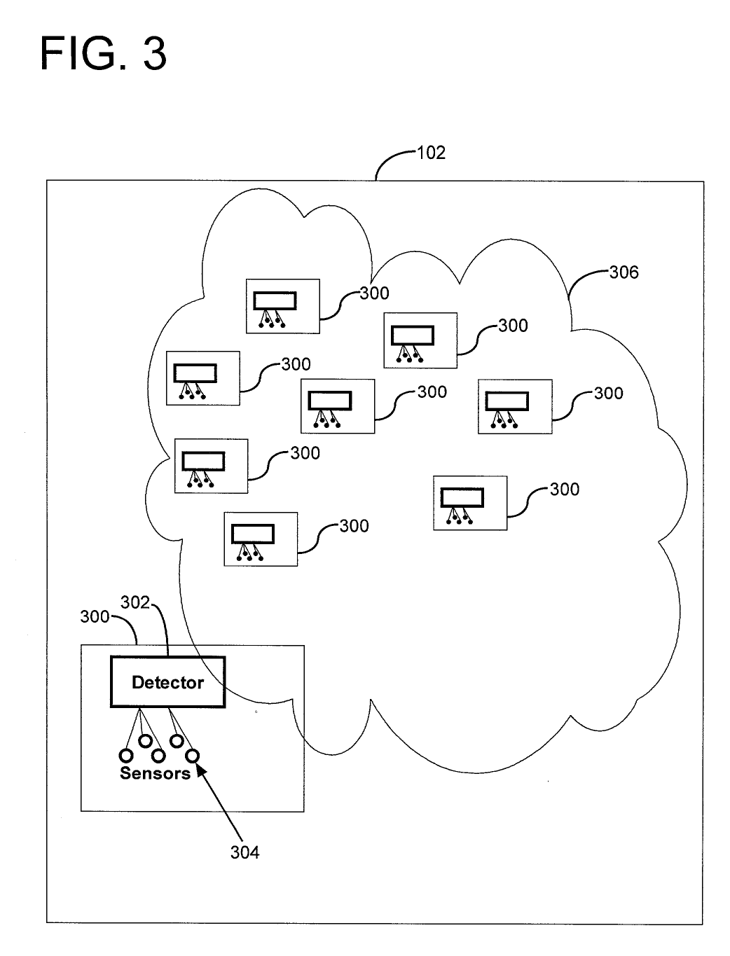

Turning now to FIG. 2, the operating environment 100 of the present invention has four levels. Level 202 includes the end user 102 and proxy/gateway 104. The equipment 300 being monitored is located in the end user location (see FIG. 3). A detector 302 that monitors the machine 300 with sensors 304 is located proximate to the machine 300. Each detector 302 is in communication with the proxy/gateway 104 via a wireless LAN 306 and sends data to an OEM server 108 if a problem is detected. Alternatively, the detector 302 communicates with the proxy/gateway 104 through a powerline carrier for signal transmission.

Returning to FIG. 2, level 204 includes an OEM server 108. The OEM server 108 hosts an expert system that analyzes the data received from the detector 302 and diagnoses the problem. If the OEM server 108 is unable to diagnose the problem, the data is sent to other OEM servers 108 that are selected by the directory server 112 in level 206.

Level 206 includes the OEM servers 108 in the network 110 and the directory server 112. When data is received from the OEM server 108 in level 2, the selected OEM servers 108 attempt to diagnose the problem. The diagnosis and solution are returned to the OEM server 108 in level 204. If the selected OEM servers 108 are unable to diagnose the problem, the data is sent to the expert network server 114.

Level 208 includes the expert network server 114 and the collaborative network 116. In level 208, experts are chosen to diagnose the problem. The experts are located throughout the world and the collaborative network 116 allows the experts to diagnose the problem without having to travel from their home locations. When the problem is diagnosed and solved, the solution is returned to the OEM server 108 in level 204.

Now that the overall system has been described, further details of the detector 302 and the process used to diagnose and solve a problem will be described. Although not required, the invention will be described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multi-processor systems, embedded devices, microprocessor based or programmable consumer electronics and consumer appliances, network PCs, minicomputers, mainframe computers, and the like. For purposes of illustration, the invention will be described in terms of monitoring a machine. Those skilled in the art will recognize that the present invention can be used on any type of installation or device where reliability is a concern and in any location (e.g., inside an installation, in an automobile or truck, in an outdoor environment, etc.)

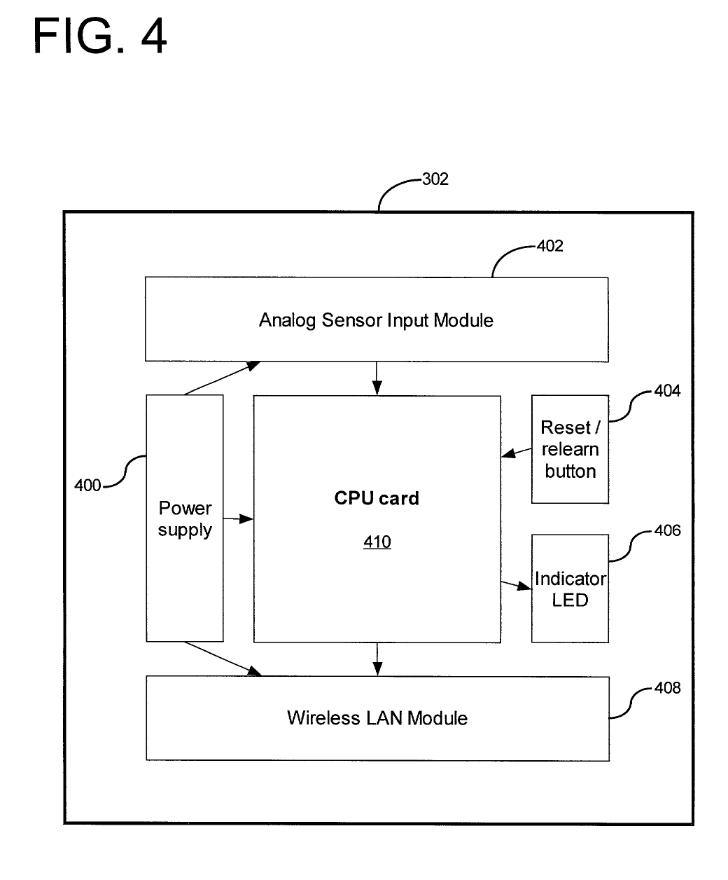

Turning now to FIG. 4, a block diagram of an embodiment of the detector 302 is shown. The detector 302 includes a power supply module 400, analog sensor input module 402, reset/relearn button 404, indicator 406, communication module 408, and a central processing unit (CPU) 410. The primary functions of the detector 302 are sensor data collection and buffering, data transformation using fast Fourier transforms (FFTs) or other transformation techniques, statistical model generation, real time model data calculation, real time decision making, sensor health monitoring, communication with the proxy/gateway 104, and local indication of machine status.

The power supply module 400 provides power to the other components of the detector 302. The analog sensor input module 402 receives and processes signals from sensors 304 mounted on or proximate to the machine 300 being monitored. The sensors 304 are connected to the analog sensor input module 402 by point-to-point wire connections, a sensor bus, or a wireless connection. The sensors 304 are used to monitor the machine's operating and condition parameters. The operating and condition parameters include parameters such as vibration, speed, rotor position, oil temperatures, inlet and outlet temperatures, bearing temperature, pressure, power draw, flow rates, harmonic content, etc. The sensors 304 include vibration sensors, temperature sensors, speed/position sensors, electrical parameter sensors (e.g., voltage and current), pressure sensors, flow rate sensors, and status inputs. The analog sensor input module 402 performs filtering and other signal conditioning when necessary. For example, vibration sensor signals typical require high pass filtering to filter out undesirable low frequency noise and at least one gain stage to optimize signal levels. Those skilled in the art will recognize that many functions of the analog sensor input module 402 may be integrated into individual sensors as sensor technology improves.

The reset/relearn button 404 is used to reset the CPU 410 and put the CPU 410 into the learning mode as will be described below. The indicator 406 comprises one or more LEDs to indicate whether or not the machine 300 is operating normally or whether an anomaly has occurred. The communication module 408 is used to communicate with the proxy/gateway 104. The communication module 408 may be an Ethernet card, a wireless LAN card using a protocol such as 802.11 b, Bluetooth, any other wireless communication protocol, or wired communication such as a powerline carrier signal.

The CPU 410 monitors the machine 300 and detects small but statistically significant signal deviations relative to normal operating conditions using statistical modeling techniques as known by those skilled in the art. The signal deviations may be indicative of future machine or component failure. The CPU 410 also monitors sensor health and excludes inputs from failed sensors, adapting the model to work with the remaining sensors. Alternatively, the CPU 410 generates replacement sensor signals for failed sensors and inputs it into the model. The detector 302 may be a stand-alone unit or integrated with other components of an installation, including operating as a software object on any processor or distributed processors having sufficient processing capability .

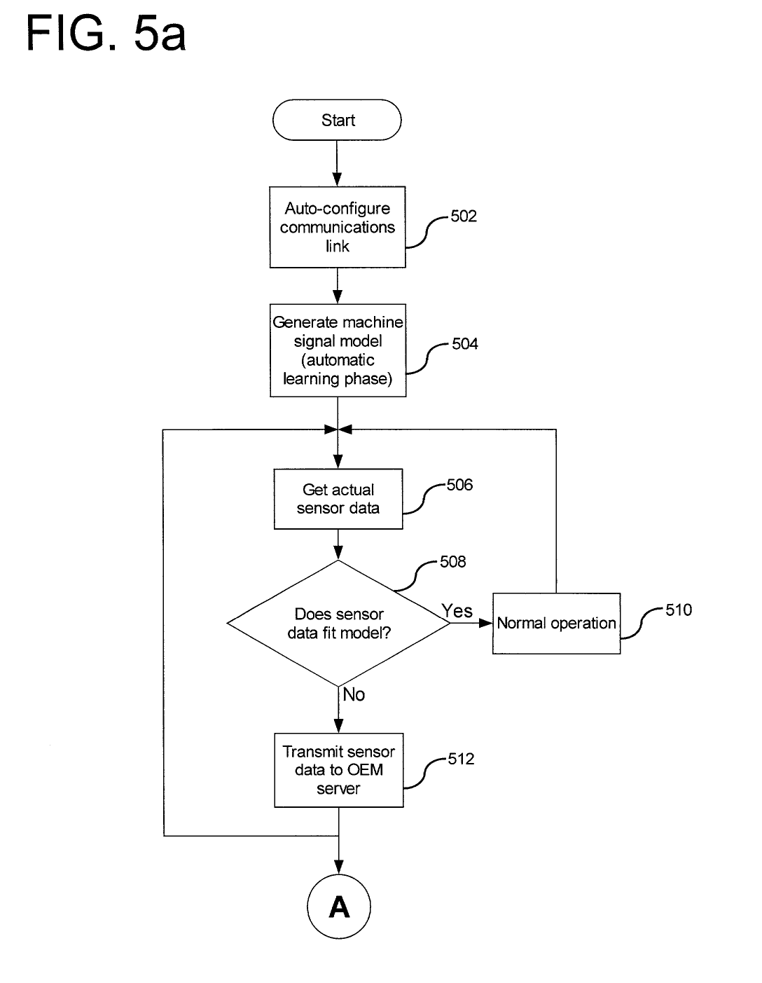

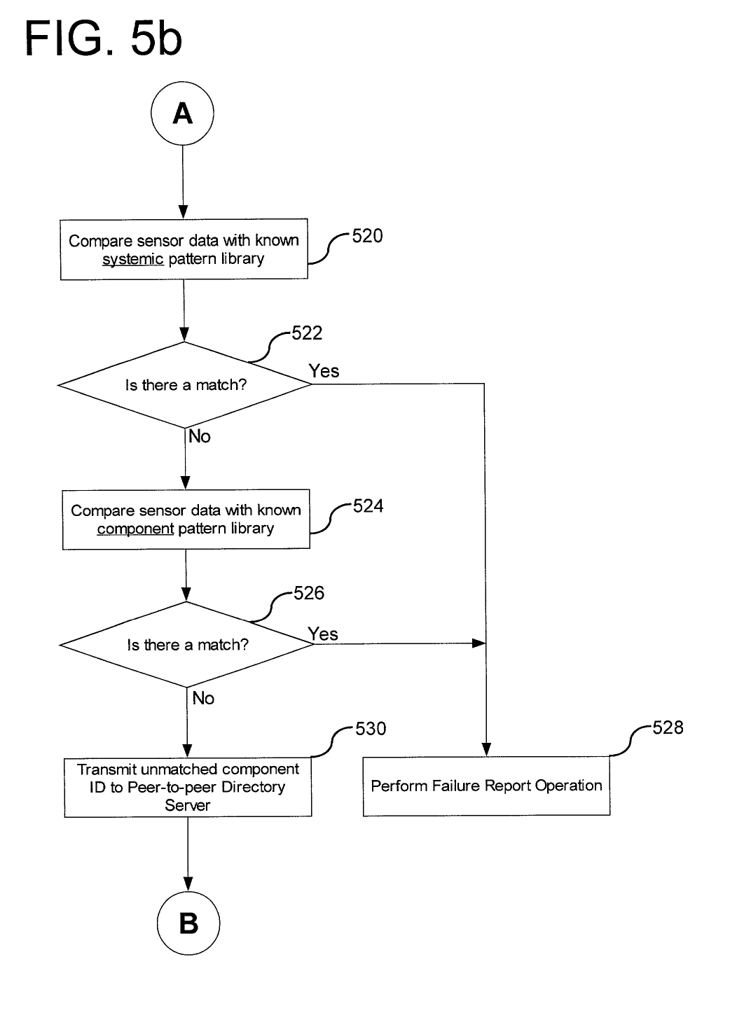

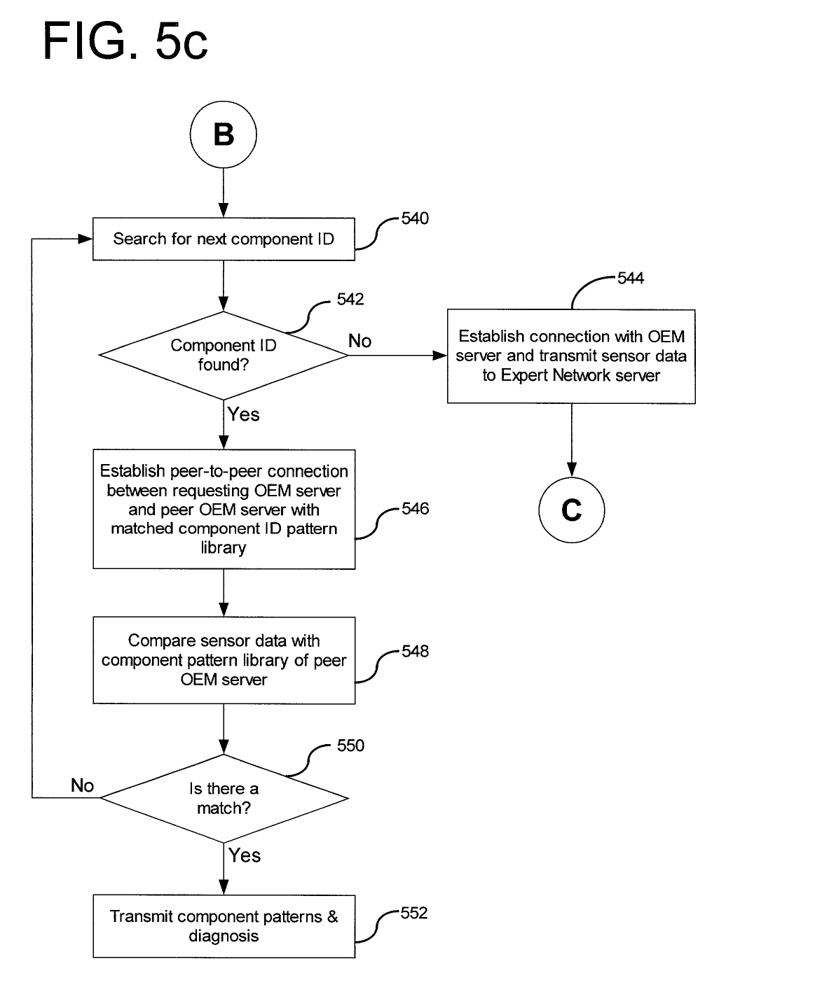

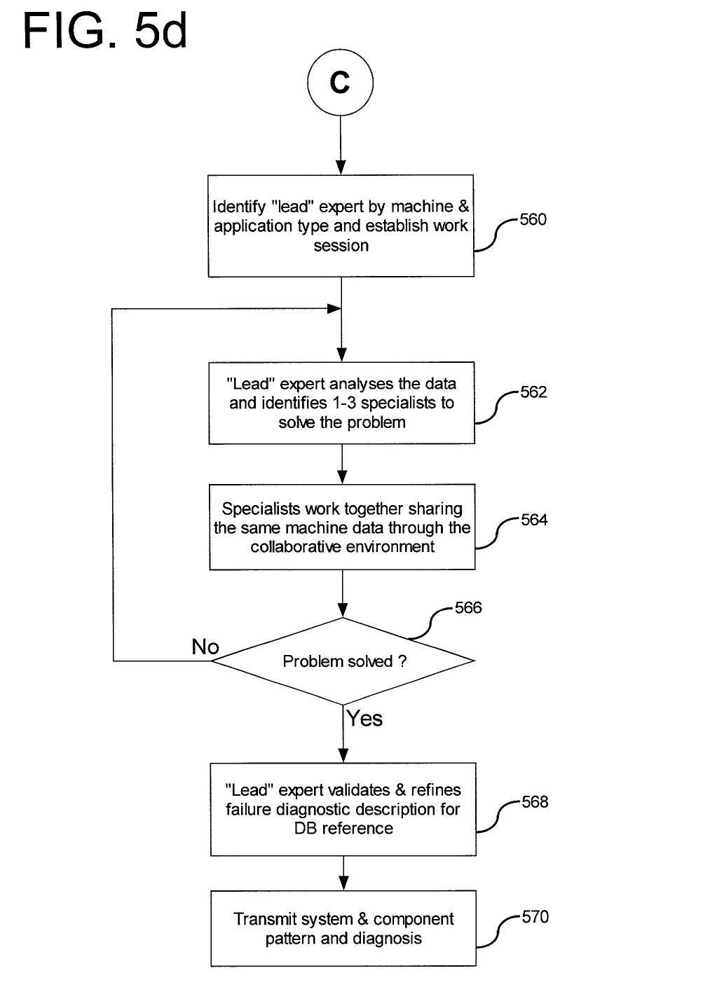

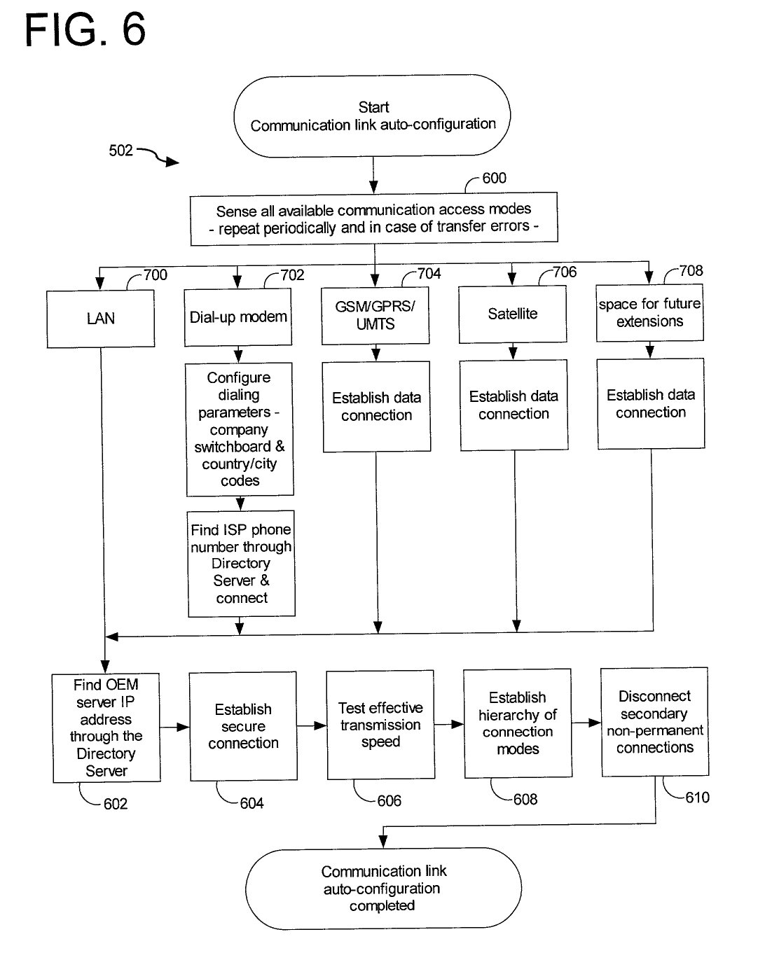

Turning now to FIGS. 5a-5d, the steps taken to monitor and diagnose a machine are shown. When the present invention is first installed in an installation, the proxy/gateway 104 performs an auto-configuration of the communications link (step 502). FIG. 6 shows one embodiment of an auto-configuration sequence. The proxy/gateway 104 senses all available communication access modes that are active (step 600). This step is repeated periodically and when transfer errors occur. The modes include LANs 700, dial-up modems 702, wireless devices 704, satellites 706, and other modes 708. For each mode that is active and available, the proxy/gateway 104 establishes a data connection, finds the OEM server 108 (step 602 ), and establishes a secure connection (step 606). In one embodiment, the establishment of the secure connection utilizes hardware and software authentication keys, authorization levels, 128 bit data encryption, data integrity checks, and data traceability. The proxy/gateway 104 tests the effective transmission speed (step 606) and establishes a hierarchy of connection modes (step 608). The hierarchy lists the available connections in order of preference. The preference is established using parameters such as transmission speed, mode reliability, and cost. Once the hierarchy is established, the non-permanent connections such as the dial-up modem are disconnected to reduce cost (step 610).

Returning now to FIG. 5a, the detector 302 generates a statistical signal model for the machine 300 (step 504). This step is performed by the detector 302 entering into a learning mode to learn how the sensor signals correlate with each other during normal operation. The detector 302 enters into the learning mode during installation and start-up and whenever the detector 302 is commanded to enter the learning mode. The command to enter the learning mode is transmitted remotely or locally. The reset/relearn button 404 is pressed to enter the learning mode locally. The remote command is received through the communication module 408. In the learning mode, the detector 302 obtains representative data (i.e. training data points) from the sensors 304 for a predetermined user-configurable number of sampling periods (e.g., sample ten sensors at a 5 kHz rate for sixty seconds). The detector 302 then fits the best reference curve(s) through the training data points as known in the art to generate the statistical model. Those skilled in the art will recognize that there are a wide variety of methods that can be used to fit the curve and a wide variety of optimization points that may be chosen. Additionally, there are a number of different types of curves that may be used (e.g., higher order curves such as second order, third order, fourth order, etc. or multiple-segment linear curves). As statistical modeling techniques improve or are developed, the detector 302 is updated with the new/improved techniques.

After the model has been generated, the detector 302 monitors the operation of the machine 300. In this phase of operation, the detector 302 obtains the processed data and performs an FFT or other transformation algorithm on the data (step 506). The detector 302 has enough memory to hold a working data buffer for the processed data (i.e., the sensor data in which filtering, amplification, integration, A/D conversion and similar operations have been applied). For example, in one embodiment, five minutes of data for ten sensors with 16 bit resolution at a 5 kHz sampling rate requires a storage capacity of approximately 30 MB. The detector 302 also maintains an incident archive and a context archive. Each archive contains 120 FFT images of all sensor data for relevant high sampling rate sensors. For example, accelerometers or current sensors would be part of the FFT images but temperature sensors would not because a single value for temperature would be sufficient. The incident archive contains one FFT per minute for two hours. The incident archive is cyclically rewritten so that after two hours, each data entry is deleted. Before deletion, one FFT per hour (i.e., two FFTs from the entire incident archive) is moved into the context archive and kept for five days (i.e., 120 hours). The data in the incident archive and context archive is not analyzed by the detector 302. In the event that sensor data does not fit the model as described below (i.e., an anomaly), the incident and context archives are transmitted to the OEM server 108 in level 204, where it is compared to the systemic pattern library. In the event that human experts are needed to solve a problem the data in the incident and context archive is transmitted to level 208 and utilized by human experts. The memory required for each archive is approximately 240 kB. It should be noted that the size (i.e., number of samples) and sampling rate of the incident and context archives can be reconfigured.

The detector 302 compares the actual sensor data to the statistical model to determine if the sensor data changes relative to the statistical model in a similar manner (step 508). This step is performed by calculating the distance between the model reference curve and each actual data point. These distance points are analyzed over a period of time. If the distance remains small and random (i.e., the sensor data fits the model), the machine 300 is operating normally (step 510) and steps 506 and 508 are repeated. A signal is sent periodically to the OEM server 108 to indicate that the machine operation is normal. If the distance does not remain small and random (i.e., the sensor data does not fit the model), the detector 302 transmits the sensor data to the OEM server 108 (step 512), provides a visual or audio alert by changing the status of the indicator LED 406, and continues monitoring the machine 300 by repeating steps 506-512. The sensor data is compressed prior to transmission (for faster and more cost-effective transmission) and sent to the OEM server 108 via the proxy/gateway 104. If the anomaly persists, the detector 302 periodically transmits transformed data in batches to the OEM server 108 in order to avoid OEM server saturation and excessive transmission costs.

In an alternate embodiment, the detector 302 does not fit a reference curve through the training data points. The detector 302 selects a relevant subset of the training data that is representative of normal machine operation and compares the actual sensor data to the subset of training data as described above. The distance between the selected training data points and actual data points is used and analyzed over a period of time. In a further alternate embodiment, virtual sensors are created for a select number of real sensors by maintaining a weighted moving average of sensor data and comparing the actual sensor data to the weighted moving average over a period of time. Those skilled in the art will realize that other alternatives may be used. The alternatives must meet the criteria of balancing robustness, accuracy, and fast model generation using standard processors.

During operation, the detector 302 also monitors the health of sensors 304. The health is monitored by first calculating an estimated sensor signal from other sensor signals and the statistical model. The difference between the estimated sensor signal and actual sensor signal is compared. If the difference is not small and random, an alert is provided that the sensor has failed. The failed sensor is excluded from further model calculation until it is repaired or replaced. After a failed sensor has been repaired or replaced, the detector 302 waits until it enters the learning mode before it uses the sensor in the model calculation. The sensor health monitoring is repeated periodically for each sensor at an appropriate period of time. For most sensors, a time period of once per second is adequate.

Turning now to FIG. 5b, the OEM server 108 in level 204 receives the sensor data transmitted by the proxy/gateway 104 and decompresses the data. The OEM server 108 hosts an expert system that has a component pattern library and a systemic pattern library. The OEM server 108 or its components (e.g., expert system) may be integrated with other components of an installation, including operating as a software object on any processor or distributed processors having sufficient processing capability. The component pattern library contains known component specific failure patterns. For example, the component pattern library may contain failure patterns for ball bearings, motors, gearboxes, cams, etc. The systemic pattern library contains systemic patterns as diagnosed by human experts. This library is updated each time an expert identifies and classifies a new pattern. The patterns can be characterized either as normal operation or as a specific failure situation. The expert system automatically generates a model of a machine's systemic behavior each time a pattern is added to the systemic pattern library.

The OEM server 108 compares the sensor data with known systemic patterns in the systemic pattern library using a model of systemic behavior (step 520). If there is a match between the sensor data and a specific failure pattern in the systemic pattern library (step 522), the OEM server 108 performs a failure report operation (step 528). The sensor data analyzed for comparison is typically the transformed FFT data. Alternatively, the sensor data is a single sample of raw data (i.e., the sensor signals prior to signal processing) or a time-series set of data. The time-series set of data contains data sets that correspond to a point of time in a time line. When the time-series set of data is used, the last data set (i.e., the last point of data in the time line) is used to select a possible failure pattern as a hypothesis. The hypothesis is compared to the other elements of the time-series set using an appropriate statistical tool to determine if the hypothesis is the likely cause of failure.

The failure report operation (step 528) includes generating an action alert, generating a report, transmitting the action alert to selected maintenance individuals or to an enterprise asset management, an enterprise resource planning program, or any other maintenance management software operated by the party responsible for maintenance. The report is added to a machine-specific database. The action alert is provided to the party responsible for maintenance of the machine 300 so that appropriate action may be taken. The action alert includes a machine identification, a time stamp, an identification of the component that is likely to fail or that has failed, an estimated time of failure, and a recommended action (i.e., replace, align, check, clean, etc.) The report added to the machine-specific database includes the action alert information and a portion of the sensor data for long term machine monitoring (e.g., historical data to see changes over time).

If there is no systemic pattern match, the sensor data is compared with known component patterns (step 524). If the sensor data matches a component pattern (step 526), the failure report operation (step 528) is performed. If there is no match, a component ID is assigned and transmitted to the directory server 112 in level 206 (step 530). The component ID is a reference number uniquely describing a machine component, such as a ball bearing, motor or gearbox, etc.. When a match and diagnosis is returned to the OEM server 108, the pattern and diagnosis is added to the component pattern library for use in matching future events.

Turning now to FIG. 5c, the directory server 112 searches for OEM servers using the same component with the same component ID sent by the OEM server 108 in level 204 (i.e., the requesting OEM server) (step 540). If a component ID matches (step 542), the directory server 112 sends the server ID of one of the OEM servers with a matching component ID. The requesting OEM server and OEM server with a matching component ID establish a peer-to-peer connection and the data is sent to the OEM server with matching component ID for analysis (step 546). The OEM server with matching component ID compares the sensor data with the system and component pattern libraries (step 548). If there is a match (step 550), the OEM server with matching component ID transmits the diagnosis and component pattern associated with the sensor data to the requesting OEM server 108 in level 204 (step 552). The requesting OEM server 108 receives the information and performs the failure report operation (step 528).

If there is no match between the sensor data and the OEM server 108 with matching component ID, steps 540 to 550 are repeated with other OEM servers 108 with matching component ID until either a match occurs or no further OEM servers 108 with matching component IDs are found. Alternatively, peer-to-peer connections are established with several OEM servers with matching component IDs so that the OEM servers can perform the sensor data comparison in parallel. If no further OEM servers with matching component IDs are found (i.e., the sensor data does not match any known patterns), the directory server 112 informs the requesting OEM server 108 and establishes a connection with expert network server 114 and transmits the sensor data to the expert network server 114 (step 544).

Turning now to FIG. 5d, the expert network server 114 receives the sensor data and determines which experts to use. The expert network server 114 identifies a lead expert from a group of experts that will become responsible for solving the problem and establishes a work session with the lead expert (step 560). The group of experts is identified by matching the expertise of the experts with the type of machine 300 that the detector 302 is monitoring. The lead expert is selected based upon a list of criteria. The list of criteria includes availability of the expert, cost, and urgency of the matter. For example, if the diagnosis must be started immediately, then the group of experts may be narrowed down to those experts that are in an appropriate time zone to start the project (e.g., if the machine problem occurred in the middle of the night in the United States, the lead expert may be chosen from the group of experts residing in that part of the world where the working day is just starting).

Once the lead expert is identified and agrees to accept the work session, the lead expert analyses the data and identifies specialists to solve the problem (step 564). The specialists work together sharing the same information in a collaborative environment to solve the problem (step 564). The collaborative environment allows the specialists to work together from remote locations. The collaborative environment is a network that provides the specialists and experts with shared access to sensor and machine data, shared access to pattern libraries, document sharing, secure (and non-secure) communications, and the ability to track individual contributions. The communications between the specialists can be voice, video, e-mail, instant messaging, co-browsing, etc. If the specialists chosen are unable to solve the problem (step 566), the lead expert selects other specialists to see if they are able to solve the problem and step 564 is repeated. The lead expert and selected specialists continue to work on the problem until the problem is solved.

Once the problem is solved, the lead expert validates the solution and determines a failure diagnostic description for placing in the database of the OEM server 108 in level 204 (step 568). The system and component patterns and diagnosis are transmitted to the OEM server 108 in level 204 (step 570). In an alternative embodiment, the system and component patterns are transmitted to all of the OEM servers that have a component ID matching the component ID sent by the requesting OEM server.

A system and method for a remote multi-level, scalable diagnosis of devices has been described. The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method for remotely monitoring and diagnosing operations of a machine, the method comprising:
detecting signals of one or more of the machine's operating and condition parameters;
comparing the detected signals to a signal model maintained locally with respect to the machine's location and identifying any anomalies in the detected signals compared to the signal model;
transmitting information describing each anomaly to a location remote from the machine;
diagnosing at the remote location the information describing the anomaly, where the diagnosis includes an initial analysis of the information by diagnostic tools maintained at the remote location, a subsequent analysis of the information by diagnostic tools maintained elsewhere if the initial analysis fails to provide a diagnosis and a final analysis by a team of humans aided by a collaborative environment if the initial and subsequent analyses fails to provide a diagnosis; and
reporting the diagnosis of the anomaly to a location capable of attending to repair of the machine.

2. The method for remotely monitoring and diagnosing operations of a machine as set forth in claim 1 wherein the step of detecting signals of machine operating and condition parameters includes continuously monitoring at least one of the operating parameters and the condition parameters.

3. The method for remotely monitoring and diagnosing operations of a machine as set forth in claim 1 wherein the signal model is a statistical model based on an initial collection of the detected signals.

4. The method for remotely monitoring and diagnosing operations of a machine as set forth in claim 1 wherein the detected signals are derived from a plurality of sensors, the method including the steps of:
identifying a failed sensor;
regenerating the signal model based on remaining sensors;
monitoring the machine based on the remaining sensors and the signal model until the failed sensor is repaired or replaced.

5. The method for remotely monitoring and diagnosing operations of a machine as set forth in claim 1 wherein the detected signals are derived from a plurality of sensors, the method including the step of generating a sensor replacement signal if the identified anomaly is based on a detected signal from a single sensor such that the replacement signal is substituted into the detected signals as a placement for the detected signal from the single sensor and the step of comparing includes the step of comparing the detected signals containing the replacement signal to the signal model.

6. The method for remotely monitoring and diagnosing operations of a machine as set forth in claim 1 including the step of adding the diagnosis to the diagnostic tools maintained at the remote location if the diagnosis is provided by one of the diagnostic tools maintained elsewhere and the team of humans.

7. A local tool positioned proximate a machine for providing an analysis of the machine's operating conditions, where the tool is connected via a communications link to a remote diagnostic tool that diagnoses an anomaly in the operation of the machine when requested by the local tool, the local tool comprising:
a plurality of sensors connected to the machine for generating information describing the operating condition of the machine;
a processor for receiving the information from the plurality of sensors, the processor including (1) a model of the information assuming normal operation of the machine, (2) instructions for analyzing the information from sensors with respect to the model and generating an exception report when the information from the plurality of sensors does not fit the model; and
an interface to the communications link for sending the exception report to the remote diagnostic tool for diagnosis.

8. The local tool of claim 7 wherein the processor includes a learning mode for generating a model of the normal operation of the machine.

9. The local tool of claim 8 wherein the local tool includes an interface for putting the processor in the learning mode.

10. The local tool of claim 8 wherein the interface is a reset button for putting the processor in the learning mode.

11. The local tool of claim 8 wherein the local tool includes a sensor conditioning module for performing signal conditioning on the information from the plurality of sensors.

12. A diagnostic tool located remotely from a machine that provides a diagnosis of an anomaly of the machine's operating conditions, where the diagnostic tool is connected via a communications link to a local tool that is located proximate the machine, and the local tool monitors the operating conditions of the machine and identifies the anomalies, the remote diagnostic tool comprising:
a first node on the communications link for diagnosing the anomaly detected by the local tool and instructions for diagnosing the anomaly using diagnostic tools available at the node;
additional nodes on the network having access to additional diagnostic tools;
an interface between the first node and the additional nodes for communicating the anomaly from the first node to the additional nodes; and
instructions at the first node for communicating the anomaly to one of the additional nodes if the diagnostic tools available at the first node are unable to provide a diagnosis of a cause of the anomaly.

13. The diagnostic tool of claim 12 wherein the local tool includes two distinctive types of pattern matching libraries.

14. The diagnostic tool of claim 13 wherein the two distinctive types of pattern matching libraries include libraries for matching systemic and component operating conditions.

15. The diagnostic tool of claim 12 where the instructions at the first node include instructions for communicating the anomaly to an expert system supported by human interaction for diagnosing the anomaly when the diagnostic tools of the first and additional nodes fail to provide a diagnosis.

16. A diagnostic tool located remotely from a machine that provides a diagnosis of an anomaly of the machine's operating conditions, where the diagnostic tool is connected via a communications link to a local tool that is located proximate the machine, and the local tool monitors operating conditions of the machine and identifies the anomalies, the remote diagnostic tool comprising:
a node on the communications link diagnosing the anomaly detected by the local tool;
diagnostic tools at the node including a first library of patterns comprising information describing systemic anomalies and a second library of patterns comprising information describing component anomalies; and
instructions at the node for diagnosing, using the first and second libraries in succession.

17. The diagnostic tool of claim 16 wherein the node is a first node and the communications link includes a second node that is connected to the first node and receives the anomaly from the first node when the first node fails to diagnose the anomaly, where the second node includes one or more human experts working in a collaborative environment to diagnose the cause of the anomaly.

18. The diagnostic tool of claim 17 wherein the communications link includes a third node that is connected to the first node and receives a diagnosis of the cause, where the third node includes one or more services capable of attending to repair of the machine.

19. The diagnostic tool of claim 17 wherein the communications link includes a fourth node that is connected to the first node and receives the anomaly from the first node when the first node fails to diagnose the anomaly, where the fourth node includes instructions for diagnosing the anomaly, and where the second node receives the anomaly from the first node if the fourth node fails to diagnose the anomaly.
